(19) United States
(12) Patent Application Publication
(10) Pub. No.: US 2003/0182521 A1
(43) Pub. Date: Sep. 25, 2003

(54) Program data rewriting system

(76) Inventor: Shigeto Suzuki, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/387,539

(22) Filed: Mar. 14, 2003

(30) Foreign Application Priority Data
Mar. 15, 2002 (JP) P2002-72408

(51) Int. Cl. G06F 12/00

(52) U.S. Cl. 711/154; 711/103

(57) ABSTRACT

A terminal apparatus attaches an in-writing signal to an e-mail by a command processing portion and develops the in-writing signal into a sending buffer during the period of writing received rewriting data. The terminal apparatus sends the e-mail to a center apparatus. In addition, after the terminal apparatus performs writing all the rewriting data and completes rewriting firmware, the terminal apparatus attaches a rewriting completion signal to e-mail by the command processing portion and develops the rewriting completion signal into the sending buffer. The terminal apparatus sends the e-mail to the center apparatus. The center apparatus judges that rewriting the firmware in the terminal apparatus is completed when the center apparatus receives the rewriting completion signal after receiving the in-writing signal from the terminal apparatus.

### BACKGROUND OF THE INVENTION

1. Field of the Invention

The present invention relates to a program data rewriting system which sends program data such as firmware and a control program or the like to be stored in a flash memory or the like installed in a terminal apparatus such as a facsimile from a center apparatus and rewrites stored program data by the sent program data.

2. Description of the Related Art

When we conventionally want to change program data such as firmware and a control program or the like to be stored in a flash memory or the like installed in a terminal apparatus such as a facsimile, rewriting data are downloaded to the terminal apparatus from a personal computer or the like connected to the terminal apparatus and stored program data are rewritten by the downloaded program data. Program data such as firmware and a control program or the like are used for controlling the terminal apparatus and therefore importance and carefulness should be required for operation of rewriting the program data.

Technology related to rewriting program data is disclosed in the following Japanese Unexamined Patent Publication: JP-A 10-27094 (1998), JP-A 2000-155683 (2000), JP-A 2000-181719 (2000) and so on.

In Japanese Unexamined Patent Publication JP-A 10-27094, a personal computer constituting a maintenance apparatus requests a handy terminal apparatus to inform the personal computer about a program version name of the handy terminal apparatus, and the handy terminal apparatus requested by the personal computer informs the personal computer about the program version name. The personal computer judges from the informed program version name whether the version of the program data that the relevant handy terminal apparatus has is the latest. The personal computer performs rewriting program data by outputting the latest program data in the relevant handy terminal apparatus in accordance with the result of the judgment.

In addition, in Japanese Unexamined Patent Publication JP-A 2000-155683, after rewriting program data is terminated in a facsimile connected to a center apparatus, the facsimile sends a rewriting confirmation information report as image data for informing whether rewriting program data is normally completed to the center apparatus.

In addition, in Japanese Unexamined Patent Publication JP-A 2000-181719, a control unit configuring an incorporated communication system transfers data for updating program with update processing program for processing the data for updating program after the data for updating program are transferred and then performs rewriting process.

As mentioned above, according to Japanese Unexamined Patent Publication JP-A 10-27094, whether the version of program data is the latest is judged and the latest program data are output in the relevant handy terminal apparatus in accordance with the result of the judgment. Therefore, updating version can be performed only for a handy terminal apparatus requiring version management without version management for an individual handy terminal apparatus, but there is not any description about confirming whether rewriting program data is normally performed and how to cope with a case in which a problem arises on rewriting program data. Consequently, there is a problem from the viewpoint of certainty of rewriting program data.

According to Japanese Unexamined Patent Publication JP-A 2000-155683, whether rewriting program data is normally completed can be confirmed by a rewriting confirmation information report, but when any problem arises on rewriting program data and process of rewriting program data is not normally completed, a system operator or the like performs the process of rewriting program data again and consequently probability of occurrence of a human error concerned with a human hand becomes high. In addition, in this case there is a problem of a long time taken by completion of rewriting program data. Furthermore, the rewriting confirmation information report is sent as image data from a communication terminal apparatus and therefore some time is required by the time of receiving the rewriting confirmation information report and there is a problem of a long time taken for confirming whether rewriting program data is normally completed.

In addition, according to Japanese Unexamined Patent Publication JP-A 2000-181719, update processing program is transferred with data for updating program and thereby rewriting data on communication equipment can be performed more flexibly, but there is not any description about confirming whether rewriting program data is normally completed and how to cope with a case of occurrence of priority interrupt process such as process of receiving a facsimile signal and process of outputting print which are original functions of the terminal apparatus. Consequently, there is a problem from the viewpoint of certainty of rewriting program data.

Furthermore, if information about rewriting program data for all the terminal apparatuses is automatically output in the center apparatus with respect to each completion of rewriting program data in the terminal apparatus, the latest information of rewriting program data can be conveniently reported to an administrator or the like, but this is not described in all the above mentioned Japanese Unexamined Patent Publications at all.

### SUMMARY OF THE INVENTION

An object of the invention is to provide a program data rewriting system enabling rewriting program data to be performed certainly and quickly and enabling the condition of rewriting program data to be understood.

The invention provides a program data rewriting system comprising a terminal apparatus including storing means which can be rewritten and in which program data are stored, and a center apparatus which sends rewriting data to be used for rewriting the program data in the terminal apparatus to the terminal apparatus, the program data rewriting system performing rewriting the program data by using a method by which the terminal apparatus receives the rewriting data sent from the center apparatus and writes the received rewriting data in the storing means, wherein the terminal apparatus comprises signal sending means for sending an in-writing signal to the center apparatus during a period of writing the received rewriting data and sending a rewriting completion signal to the center apparatus after all the rewriting data are written and a rewriting of program data is completed, and the center apparatus comprises condition confirming means for judging that the rewriting of the program data in the terminal apparatus is completed when the rewriting completion signal is received after receiving the in-writing signal from the terminal apparatus.

According to the invention, when the terminal apparatus rewrites program data by receiving rewriting data sent from the center apparatus and writing the rewriting data in the storing means, the signal sending means of the terminal apparatus sends the in-writing signal to the center apparatus during the period of writing the received rewriting data and sends the rewriting completion signal to the center apparatus after all the rewriting data are written and the rewriting of the program data is completed.

When the condition confirming means of the center apparatus receives the rewriting completion signal after receiving the in-writing signal from the terminal apparatus, the condition confirming means judges that the rewriting of the program data is completed in the terminal apparatus.

Thus, during the period of writing the rewriting data, the terminal apparatus sends the in-writing signal to the center apparatus. When rewriting is completed, the terminal apparatus sends the rewriting completion signal to the center apparatus. Therefore, the center apparatus can confirm the condition of rewriting program data in the terminal apparatus. In addition, the center apparatus judges that the rewriting of the program data is completed in the terminal apparatus only when the rewriting completion signal is received after receiving the in-writing signal from the terminal apparatus. Therefore, for instance, when the writing completion signal is accidentally sent in spite of the in-writing state, rewriting process is not completed. This can prevent malfunction by which rewriting process is completed in spite of the fact that rewriting program data is not correctly performed and rewriting program data can be certainly performed.

In addition, In the invention it is preferable that the center apparatus sends a confirming signal for confirming a condition of rewriting the program data in the terminal apparatus to the terminal apparatus by the condition confirming means after sending the rewriting data, and the terminal apparatus sends the in-writing signal or the rewriting completion signal by the signal sending means after receiving the confirming signal.

According to the invention, the center apparatus sends a confirming signal to the terminal apparatus by the condition confirming means so as to confirm the condition of rewriting program data in the terminal apparatus after sending the rewriting data. The terminal apparatus responds to the confirming signal by sending the in-writing signal or the rewriting completion signal corresponding to the condition of rewriting program data to the center apparatus.

Thus, the center apparatus receives the in-writing signal or the rewriting completion signal as response to the confirming signal. Therefore, the condition of rewriting program data in the terminal apparatus can be grasped and rewriting program data can be performed more certainly.

In addition, in the invention it is preferable that the confirming signal is sent more than one time.

According to the invention, the confirming signal is sent more than one time by the condition confirming means and therefore, even when the terminal apparatus does not respond to the confirming signal because of some reason, the condition of rewriting program data in the terminal apparatus can be certainly grasped and rewriting program data can be performed further certainly by a subsequent confirming signal.

In addition, in the invention it is preferable that the terminal apparatus further comprises checking means for checking whether an error occurs in the received data or not, and the terminal apparatus sends the in-writing signal to the center apparatus by the signal sending means when the rewriting data are checked by the checking means after the terminal apparatus receives the rewriting data and any error does not occur in the received data.

According to the invention, the checking means of the terminal apparatus checks whether an error occurs in the rewriting data or not when the terminal apparatus receives the rewriting data. When any error occurs in the rewriting data, the signal sending means sends the in-writing signal to the center apparatus.

Thus, by writing the rewriting data after checking the received rewriting data by the checking means, the terminal apparatus can write normal rewriting data without any error in the storing means and can perform the rewriting of the program data certainly. In addition, the terminal apparatus sends the in-writing signal to the center apparatus by the signal sending means when any error does not occur in the rewriting data. Therefore, the center apparatus can confirm the condition of receiving the rewriting data in the terminal apparatus by the in-writing signal.

In addition, in the invention it is preferable that the terminal apparatus further comprises checking means for checking whether an error occurs in the received data or not, and the terminal apparatus sends a receiving error signal to the center apparatus by the signal sending means when the rewriting data are checked by the checking means after the terminal apparatus receives the rewriting data and an error occurs in the received data, and the center apparatus resends the rewriting data after the center apparatus receives the receiving error signal.

According to the invention, the checking means of the terminal apparatus checks whether an error occurs in the rewriting data or not when the checking means receives the rewriting data. When an error occurs in the rewriting data, the signal sending means sends the receiving error signal to the center apparatus. And, the center apparatus that received the receiving error signal resends the rewriting data by the communication means.

When an error thus occurs in the rewriting data, the terminal apparatus sends the receiving error signal to the center apparatus. Therefore, the center apparatus can confirm by the received error signal that the error occurs in rewriting data at the time of receiving the rewriting data in the terminal apparatus. In addition, when the center apparatus receives the receiving error signal, the center apparatus resends the rewriting data to the terminal apparatus. Therefore, the rewriting of the program data can be certainly performed. In addition, the resending of the rewriting data is automatically started by receiving the receiving error signal of the center apparatus. Consequently, process from checking the error in the rewriting data to resending the rewriting data can be performed quickly and occurrence of a human error can be restrained because of no chance of concernment of a human hand for the process and the rewriting of the program data can be certainly performed.

In addition, in the invention it is preferable that the terminal apparatus further comprises instruction means for instructing a start of rewriting the program data, and sends a rewriting start signal to the center apparatus according to an instruction of rewriting the program data from the instruction means, and the center apparatus sends the rewriting data to the terminal apparatus after receiving the rewriting start signal.

According to the invention, when the instruction means in the terminal apparatus instructs rewriting process to be performed, the terminal apparatus sends the rewriting start signal to the center apparatus. After the center apparatus receives the rewriting start signal, the center apparatus sends the rewriting data to the terminal apparatus and this leads to a start of rewriting program data.

Thus, after rewriting program data is instructed to the center apparatus by the instruction means, in other words, rewriting of program data is approved, the rewriting of the program data is started. Therefore, a start of rewriting program data caused by operation mistake or the like can be prevented.

In addition, in the invention it is preferable that the rewriting completion signal includes information about version and date and time of rewriting completion respectively of the program data.

According to the invention, the rewriting completion signal includes information of the version and the date and time of rewriting completion respectively of program data. This enables the center apparatus which receives the rewriting completion signal to get not only information about the effect that the rewriting of the program data is completed but information about what version of program data is rewritten and when a rewriting of program data is completed.

In addition, in the invention it is preferable that the center apparatus sends the rewriting data to a plurality of terminal apparatuses and performs rewriting program data, and the center apparatus further comprises rewriting information storing means for storing rewriting information about what terminal apparatus is completed and what terminal apparatus is not completed concerning rewriting of program data, among the terminal apparatuses.

According to the invention, the rewriting information storing means of the center apparatus stores rewriting information about what terminal apparatus is completed and what terminal apparatus is not completed concerning rewriting program data, among the terminal apparatuses. This rewriting information enables the center apparatus to judge whether the rewriting of the program data is required for all the terminal apparatuses and to perform management of the terminal apparatuses efficiently.

In addition, in the invention it is preferable that the center apparatus further comprises output means for outputting the rewriting information.

According to the invention, the rewriting information can be output by the output means of the center apparatus at every completion of rewriting of program data in the terminal apparatus and therefore the latest information about the rewriting of the program data can be reported to the administrator of the program data rewriting system.

In addition, in the invention it is preferable that the in-writing signal, the confirming signal, the rewriting completion signal and the receiving error signal are signals which are sent and received in accordance with a predetermined rule between the terminal apparatus and the center apparatus.

According to the invention, rewriting program data is performed by using the in-writing signal, the confirming signal, the rewriting completion signal and the receiving error signal which are signals sent and received in accordance with the predetermined rule between the terminal apparatus and the center apparatus. Thus, exchange of information can be quickly performed between the terminal apparatus and the center apparatus by using signals which are sent and received in accordance with the predetermined rule. This enables rewriting program data to be performed quickly. In addition, the in-writing signal, the confirming signal, the rewriting completion signal and the receiving error signal are sent and received in accordance with the predetermined rule, but these signals can be sent and received similarly as e-mail because these signals can be attached to a data frame of an e-mail.

In addition, in the invention it is preferable that the program data are firmware.

According to the invention, rewriting firmware can be performed.

### BRIEF DESCRIPTION OF THE DRAWINGS

Other and further objects, features, and advantages of the invention will be more explicit from the following detailed description taken with reference to the drawings wherein:

FIG. 1 is a block diagram showing a configuration of a terminal apparatus;

FIG. 2 is a block diagram showing a configuration of a center apparatus;

FIG. 3 is a flowchart showing a request process for a rewriting start in the terminal apparatus;

FIG. 4 is a view showing a data frame of data attached to an e-mail;

FIG. 5 is a flowchart showing a sending process of rewriting data 31 in the center apparatus;

FIG. 6 is a table showing information about rewriting data in a terminal apparatus managing information file shown in FIG. 2;

FIG. 7 is a flowchart showing a rewriting process of firmware in the terminal apparatus;

FIG. 8 is a flowchart showing details of process of sending the in-writing code at step c18;

FIG. 9 is a flowchart showing a confirming process of a rewriting condition in the center apparatus;

FIG. 10 is a flowchart showing a resending process of rewriting data in the center apparatus;

FIG. 11 is a flowchart showing a sending process of a rewriting completion code in the terminal apparatus;

FIG. 12 is a time chart showing a schematic view of a rewriting process of firmware in the program data rewriting system;

FIG. 13 is a flowchart showing an output process of rewriting information in the center apparatus; and

FIG. 14 is a table showing rewriting information which is output.

### DETAILED DESCRIPTION OF THE PREFERRED EMBODIMENTS

Now referring to the drawings, preferred embodiments of the invention are described below.

A terminal apparatus according to the invention is, for instance, a facsimile apparatus which is always connected to LAN (Local Area Network), and a center apparatus according to the invention is, for instance, an apparatus installed at a predetermined service center. In this case, program data that become an object of rewriting is firmware or the like stored in a flash memory of the facsimile apparatus.

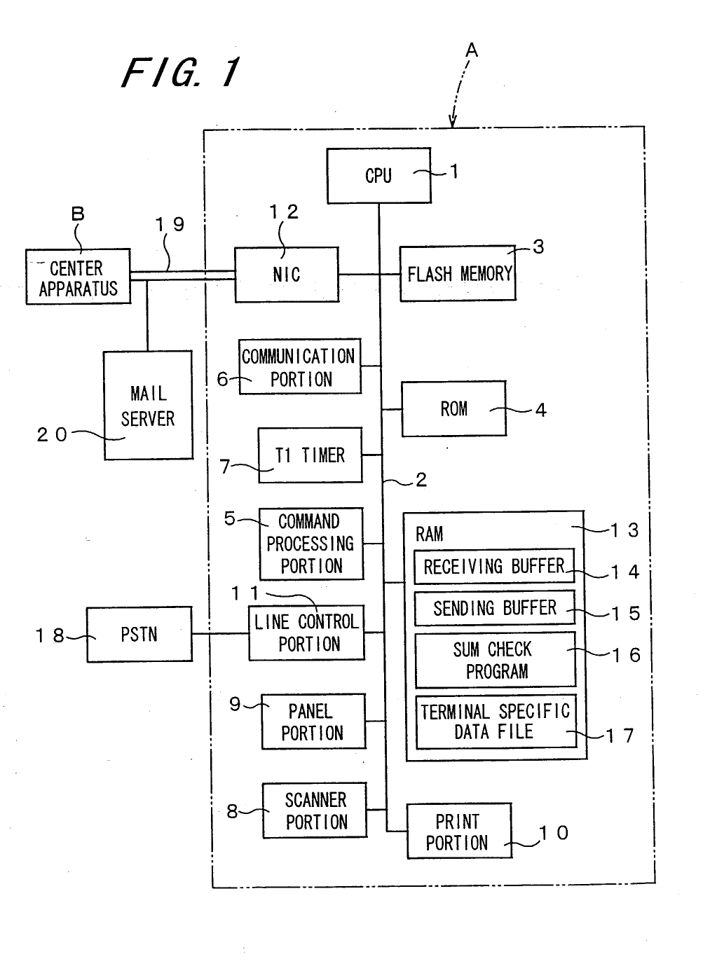

FIG. 1 is a block diagram showing configuration of the terminal apparatus A. The terminal apparatus A comprises a CPU (Center Processing Unit) 1, a data bus 2, a flash memory 3, a ROM (Read Only Memory) 4, a command processing portion 5, a communication portion 6, a T1 timer 7, a scanner portion 8, a panel portion 9, a print portion 10, a line control portion 11, an NIC (Network Interface Card) 12 and a RAM (Random Access Memory) 13.

The CPU 1 performs an operation process and a control in the terminal apparatus A. The data bus 2 is a transmission line of internal data in the terminal apparatus A. The flash memory 3 is a nonvolatile memory which can be rewritten and in which a control program and firmware of the terminal apparatus A are stored. The ROM 4 is a nonvolatile memory storing a program dedicated to rewriting for performing rewriting of the control program and the firmware of the terminal apparatus A which are stored in the flash memory 3. The command processing portion 5 performs a judgment process of various types of received commands and codes. The communication portion 6 has a program for controlling a line and performs a management of the line and a control of communication start and end. In addition, the communication portion 6 performs a conversion between sending/receiving data and the internal data and detects and corrects an error in communication.

The T1 timer 7 performs clocking of the set time. The scanner portion 8 performs reading and downloading of image data. The panel portion 9 includes a key input portion and a display portion to perform a key input and a display. The print portion 10 performs printing of the image data and character data. The line control portion 11 has a modem function for connection to PSTN (Public Switched Telephone Network) 18. The NIC (Network Interface Card) 12 is an expansion card available for connection to a LAN 19 through a program such as a LAN driver or the like. The terminal apparatus A is connected to the LAN 19 by the NIC 12 and performs communication to the center apparatus B, a mail server 20 and other terminal apparatus A.

The RAM 13 includes a receiving buffer 14 and a sending buffer 15 and has a sum check program 16 and a terminal specific data file 17. The receiving buffer 14 and the sending buffer 15 are memories that are temporarily utilized for processing receiving data and sending data. The sum check program 16 is a program that checks whether an error occurs in the received data. A terminal specific data file 17 is a file that stores specific data of the terminal apparatus A. This specific data includes information about rewriting firmware of the terminal apparatus A.

In addition, the flash memory 3 constitutes storing means. The command processing portion 5, the communication portion 6, the NIC 12, the data bus 2 and the CPU 1 constitute signal sending means. The sum check program 16, the data bus 2 and the CPU 1 constitute checking means. The panel portion 9, the data bus 2 and the CPU 1 constitute instruction means.

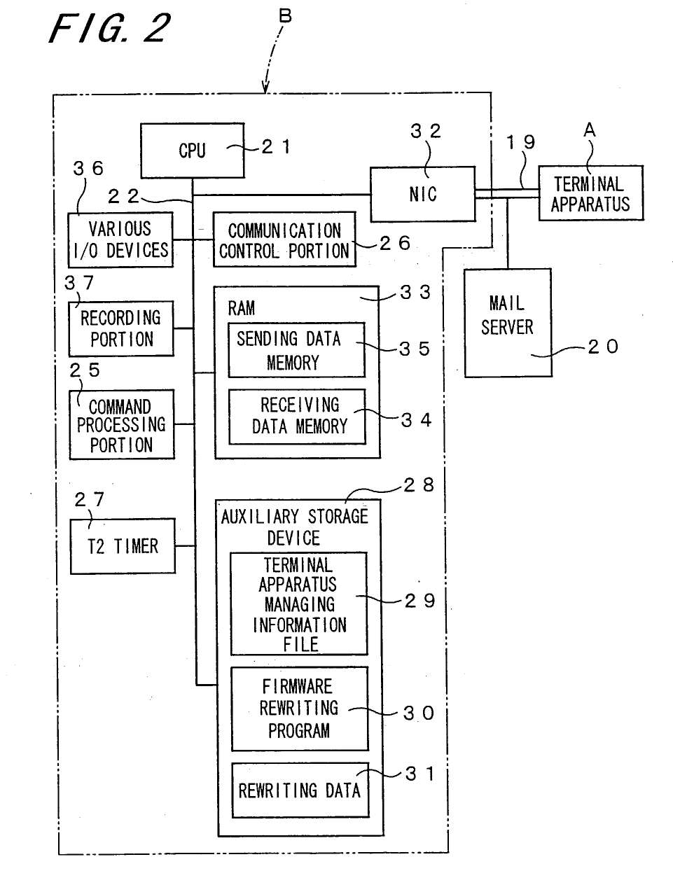

FIG. 2 is a block diagram showing configuration of the center apparatus B. The center apparatus B comprises a CPU 21, a data bus 22, a command processing portion 25, a communication control portion 26, a T2 timer 27, an auxiliary storage device 28, an NIC 32, a RAM 33 and various I/O (Input/Output) devices 36 and a recording portion 37.

The CPU 21 performs an operation process and a control in the center apparatus B. The data bus 22 is a transmission line of internal data in the center apparatus B. The command processing portion 25 performs a judgment process of various types of received commands and codes. The communication portion 26 has a program for controlling a line and performs a line control and a control of communication start and end. In addition, the communication control portion 26 performs a conversion between sending/receiving data and internal data and also detects and corrects an error in communication. The T2 timer 27 performs clocking of the set time.

The auxiliary storage device 28 is a hard disk for storing a terminal apparatus managing information file 29, a firmware rewriting program 30 and a rewriting data 31. The terminal apparatus managing information file 29 performs a management of rewriting information of the terminal apparatus A. The firmware rewriting program 30 is a program for performing a rewriting process of firmware. The rewriting data 31 are data which are written in the flash memory 3 of the terminal apparatus A for the purpose of rewriting firmware.

The NIC 32 is an expansion card available for connection to LAN 19 through the program named LAN driver. The center apparatus B is connected to the LAN 19 by the NIC 32 and performs communication to the terminal apparatus A and the mail server 20.

In addition, the command processing portion 25, the communication control portion 26, the NIC 32, the data bus 22 and the CPU 21 constitute condition confirming means. The terminal apparatus managing information file 29, the data bus 22 and the CPU 21 constitute rewriting information storing means. The terminal apparatus managing information file 29, the recording portion 37, various I/O devices 36, the data bus 22 and the CPU 21 constitute output means.

The RAM 33 has a sending data memory 35 and a receiving data memory 34. The receiving data memory 34 and the sending data memory 35 are memories that are temporarily utilized for processing receiving data and sending data. The various I/O devices 36 are Input/Output devices including a keyboard and a display portion. The recording portion 37 performs a printing of image data and character data.

Next, a procedure of rewriting firmware in a program data rewriting system is described. Overview of the procedure of rewriting firmware is as follows.

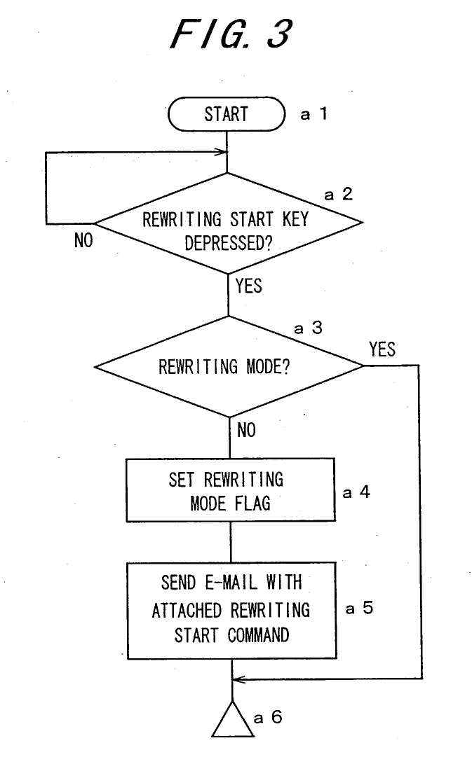

First, the terminal apparatus A performs a request process for a rewriting start to send a rewriting start command to the center apparatus B. The center apparatus B that received this rewriting start command performs a rewriting data sending process to send the rewriting data 31 to the terminal apparatus A. And, the terminal apparatus A that received the rewriting data 31 performs the rewriting process to rewrite firmware with use of the rewriting data 31. While the terminal apparatus A is performing the rewriting of firmware, the center apparatus B performs a confirming process of a rewriting condition to confirm the rewriting condition to the terminal apparatus A. And, when the rewriting of firmware is completed, the terminal apparatus A performs a sending process of a rewriting completion code to send the rewriting completion code. A sequence of these processes is described in detail with use of FIG. 3 through FIG. 11.

FIG. 3 is a flowchart showing the request process for the rewriting start in the terminal apparatus A. A system operator is present in the terminal apparatus A side. When the system operator receives a notification that the firmware is required to be rewritten from the center apparatus B through the terminal apparatus A, the system operator depresses a rewriting start key arranged on the panel portion 9 as the instruction means of the terminal apparatus A. When the rewriting start key is depressed, at step a1 the request process for the rewriting start is started in the terminal apparatus A. In addition, the rewriting start key also has a function of approving rewriting, and a start of rewriting caused by an operation mistake can be prevented since rewriting is started after the rewriting start key is depressed.

At step a2, the terminal apparatus A confirms whether the rewriting start key is depressed. When depressing of the rewriting start key is confirmed, the process proceeds to step a3. Thus, the terminal apparatus A activates a program dedicated to rewriting built in the ROM 4 by depressing the rewriting start key and performs the process for rewriting the firmware in accordance with the program dedicated to rewriting. In addition, the program dedicated to rewriting controls the terminal apparatus A so that all of a sequence of the rewriting process including not only a control of work for rewriting the firmware but also a control of sending and receiving the e-mail between the terminal apparatus A and the center apparatus B, can be automatically performed.

On the other hand, when depressing of the rewriting start key is not confirmed, a waiting state is continued until depressing the rewriting start key is confirmed. At step a3, the terminal apparatus A checks a rewriting mode flag in the CPU 1 to judge whether the terminal apparatus A is in a rewriting mode. The rewriting mode flag indicates whether rewriting is performed in the terminal apparatus A. When the rewriting mode flag is set, the terminal apparatus A is in a state of performing the rewriting. And when the rewriting mode flag is not set, the terminal apparatus A is in a state of performing no rewriting. When the terminal apparatus A is in the rewriting mode, the process proceeds to step a6.

On the other hand, when the terminal apparatus A is not in the rewriting mode, the process proceeds to step a4. At the step a4, the terminal apparatus A sets the rewriting mode flag. This makes the terminal apparatus A be in the rewriting mode. At step a5, the terminal apparatus A sends an e-mail with an attached rewriting start command to the center apparatus B in order to request the center apparatus B to start a rewriting of firmware. This rewriting start command is one of signals that are sent and received in accordance with the predetermined rule between the terminal apparatus A and the center apparatus B and is attached to the head of the data frame as attached data to the e-mail. The e-mail with the attached rewriting start command is sent to an e-mail address of the center apparatus B as a sending address. In addition, sending and receiving of e-mail can be performed by general e-mail software and the attached data are treated in accordance with the predetermined rule between the terminal apparatus A and the center apparatus B under the condition of activation of the firmware rewriting program 30. And at step 6, the terminal apparatus A terminates the request process for rewriting start.

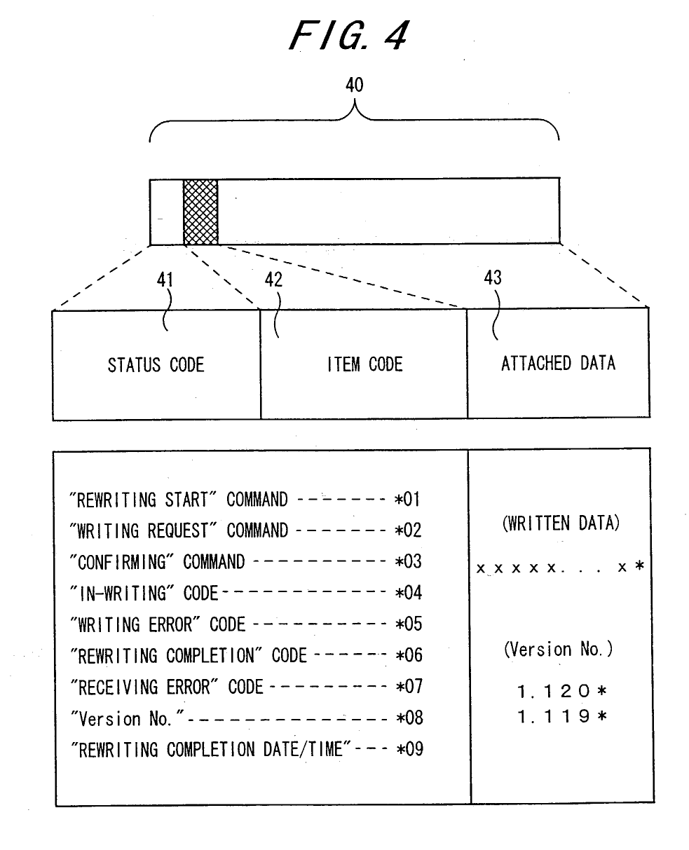

FIG. 4 is a view showing the data frame 40 of the data attached to e-mail. A status code 41, an item code 42 and an attachment data 43 are attached to the data frame 40 of the data attached to the e-mail. A signal sent and received in accordance with the predetermined rule between the terminal apparatus A and the center apparatus B is attached to the data frame 40 as attached data. In addition, the data lengths of the status code 41 and the item code 42 are approximately several bytes respectively and are not restricted in particular, but are defined as 3 bytes respectively in the embodiment of the invention.

Commands attached as attached data include a “Rewriting start” command, a “Writing request” command and a “Confirming” command. The rewriting start command is sent from the terminal apparatus A and is a rewriting start signal for requesting the center apparatus B to start rewriting, and a command number of the rewriting start command is *01. The writing request command is a command which is sent with the rewriting data 31 from the center apparatus B having received the request for writing start and requests writing of the rewriting data 31 in the flash memory 3 in the terminal apparatus A. A command number of the writing request command is *02. The confirming command is sent from the center apparatus B after a start of rewriting and is a confirming signal for confirming the rewriting condition of firmware in the terminal apparatus A. A command number of the confirming command is *03.

Codes attached as attached data include an “In-writing” code, a “Writing error” code, a “Rewriting completion” code and a “Receiving error” code. Among these codes, the in-writing code and the rewriting completion code are response codes to the confirming command. The in-writing code is an in-writing signal which is sent during a period of performing the writing of the rewriting data 31 in the terminal apparatus A, and a code number of the in-writing code is *04. The writing error code is a code which is sent from the terminal apparatus A to the center apparatus B in the case of occurrence of any error at the time of completion of rewriting the firmware, and a code number of the writing error code is *05. The rewriting completion code is a rewriting completion signal which is sent after completion of rewriting the firmware, and a code number of the rewriting completion code is *06. The receiving error code is a receiving error signal which is sent by the terminal apparatus A in the case of occurrence of an error in rewriting data 31. The receiving error code is also a code which is sent from the center apparatus B for giving notification that rewriting of firmware is not required because the terminal apparatus A having sent the writing start command already has the latest firmware. A code number of the writing error code is *07.

There are “Version No.” data and “Rewriting completion date and time” data as other data attached as attached data. In addition, the version No. data are related to information about a version of firmware that the terminal apparatus A has and the rewriting completion date and time data are related to information about the date and time on which rewriting the firmware has been completed. These data are sent from the terminal apparatus A to the center apparatus B to notify the center apparatus B of information about the version No. of the firmware and the rewriting completion date and time as additional information with the above mentioned rewriting completion code. A code number of the Version No. data is *08. A code number of rewriting completion date and time data is *09.

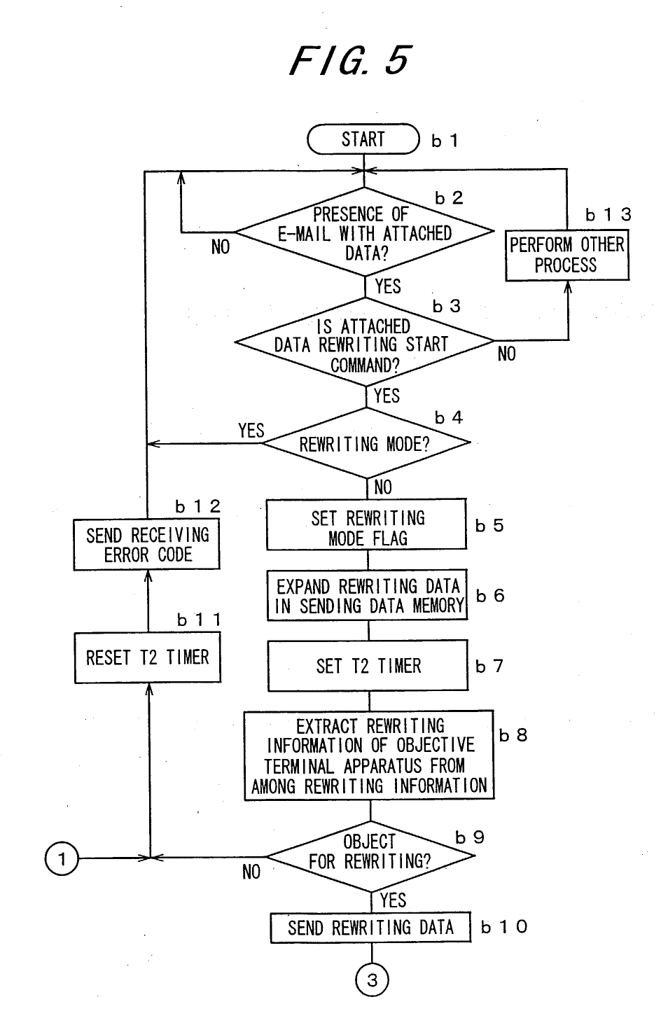

Next, description is given concerning a procedure in which the center apparatus B having received the rewriting start command from the terminal apparatus A sends the rewriting data 31. FIG. 5 is a flowchart showing a sending process of rewriting data 31 in the center apparatus B.

At step b1, the sending process of the rewriting data 31 is started in the center apparatus B. At step b2, the center apparatus B confirms whether the center apparatus B receives an e-mail with attached data. When the center apparatus B receives the e-mail, the process proceeds to step b3. When the center apparatus B does not receive the e-mail, the process enters a waiting state. Whether the e-mail has the attached data is judged from presence or absence of a signal that the e-mail has attached data on a predetermined position of the e-mail. In addition, when the e-mail does not have attached data, the e-mail is treated as normal e-mail.

At the step b3, the center apparatus B investigates whether the attached data of the e-mail is the rewriting-start command by the command processing portion 25. When the attached data is the rewriting start command, the process proceeds to step b4. When the attached data is not the rewriting start command, the process proceeds to step b13. At the stepb13, other process is performed on the basis of the data attached to the received e-mail.

At the step b4, the center apparatus B confirms whether the center apparatus B is in the rewriting mode. When the center apparatus B is in the rewriting mode, the center apparatus B judges whether the rewriting mode is a rewriting mode for the terminal apparatus A to which the rewriting start command has been sent. Concretely, the center apparatus B confirms whether a rewriting mode flag in the CPU 21 is set and whether the rewriting mode is a rewriting mode for the objective terminal apparatus A. When the rewriting mode flag is set, the process returns to the step b2. When the rewriting mode flag is not set, the process proceeds to step b5.

At the step b5, the center apparatus B sets the rewriting mode flag. This makes the center apparatus B be in the rewriting mode for the terminal apparatus A to which rewriting start is requested and a firmware rewriting program 30 is activated in the center apparatus B by this process that the rewriting mode flag is set.

At step b6, the center apparatus B retrieves the rewriting data 31 from the auxiliary storage device 28 to send the rewriting data 31 to the terminal apparatus A and expands the retrieved rewriting data 31 in the sending data memory 35. The center apparatus B attaches a writing request command requesting writing the rewriting data 31 as the status code 41 to the data frame 40 of the data attached to the e-mail and attaches the Version No. code as the item code 42 to the data frame 40 with this rewriting data 31. The center apparatus B actually attaches the command number “*02” of the writing request command as the status code 41 and the code number “*08” of the Version No. code as the item code 42 respectively to the data frame 40. Thus, the rewriting data 31, the rewriting request command for requesting the terminal apparatus A to write the rewriting data 31 and the version number of the firmware are included in the e-mail.

Next, at step b7, the T2 timer 27 is set with a setting time τ2=80 sec. This time of 80 sec. corresponds to a sending cycle of the confirming command sent from the center apparatus B in order to confirm the rewriting condition of the firmware.

At step b8, the center apparatus B extracts rewriting information of a relevant terminal apparatus A from among rewriting information in the terminal apparatus managing information file 29. At step b9, the center apparatus B judges whether the relevant terminal apparatus A corresponds to an object of rewriting.

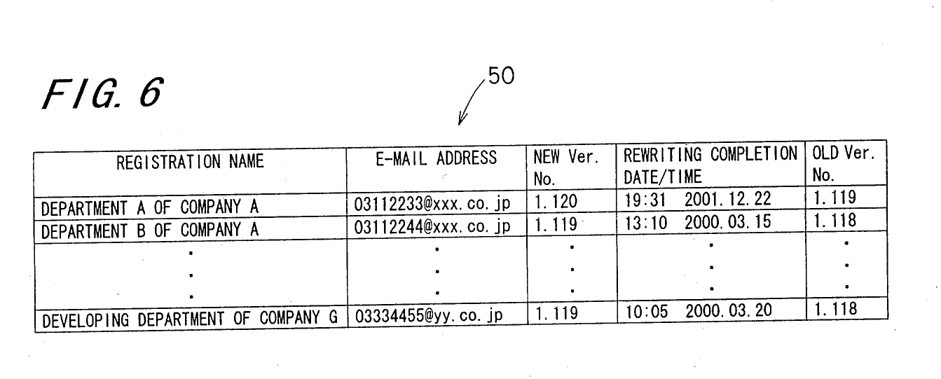

Here, rewriting information is explained. FIG. 6 is a table showing rewriting information 50 in the terminal apparatus managing information file 29 shown in FIG. 2. The rewriting information 50 comprises information about a plurality of the terminal apparatuses A and includes information about a registration name, an e-mail address, a new Version No., rewriting completion date/time and an old Version No. The new Version No. means the current Version No. of the firmware of the terminal apparatus A, and the old Version No. means aversion No. before being rewritten in the current version. In addition, extraction of the rewriting information 50 of the terminal apparatus A is performed by the center apparatus B by means of collating the e-mail address of the terminal apparatus A included in the e-mail sent from the terminal apparatus A with the e-mail address of the rewriting information 50.

Here, the latest version number of the firmware is 1.120 and therefore this means that the terminal A installed at the department A of the company A and having new version number 1.120 completed rewriting the firmware on Dec. 22, 2001. On the other hand, both of a new Ver. Nos. of the terminal apparatuses A installed at the department B of the company A and installed at the development department B of the company G are 1.119 and therefore both of these terminal apparatuses A correspond to objects of rewriting.

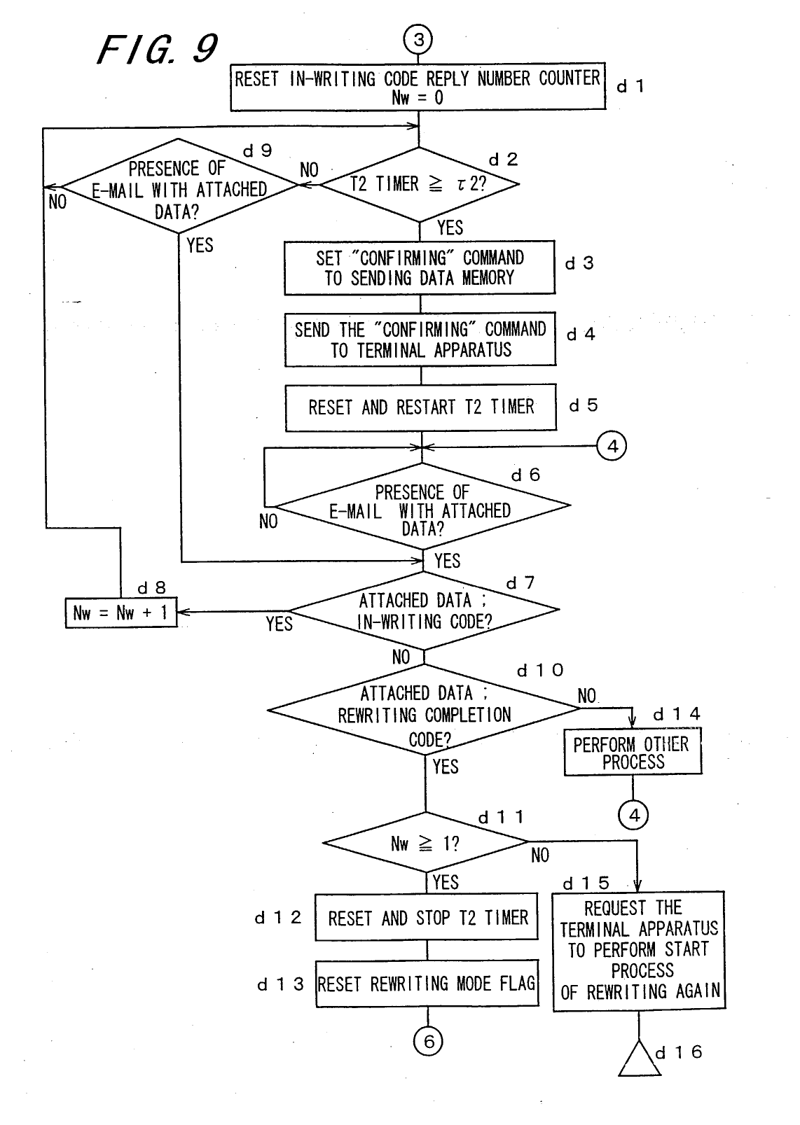

Thus, when the center apparatus B judges from the rewriting information 50 of the above mentioned terminal apparatus managing information file 29 that the terminal apparatus A to which the rewriting start command is sent is an object of rewriting, the process proceeds to step b10. When the center apparatus B judges that the terminal apparatus A is not an object of rewriting, the process proceeds to step b11. At the step b10, the center apparatus B sends the rewriting data 31 which is expanded in the sending data memory 35 to the terminal apparatus A which becomes an object of rewriting and then the process proceeds to the flowchart in FIG. 9. On the other hand, at step b11, the center apparatus B resets the T2 timer 27, and at step b12, the center apparatus B sends the receiving error code to the terminal apparatus A. This can make the terminal apparatus A recognize that the terminal apparatus A itself is not an object of rewriting and rewriting the terminal apparatus A is not required.

Next, description is given concerning a procedure in which the terminal apparatus A which received the rewriting data 31 sent from the center apparatus B performs writing the rewriting data 31 and rewriting of the firmware is completed.

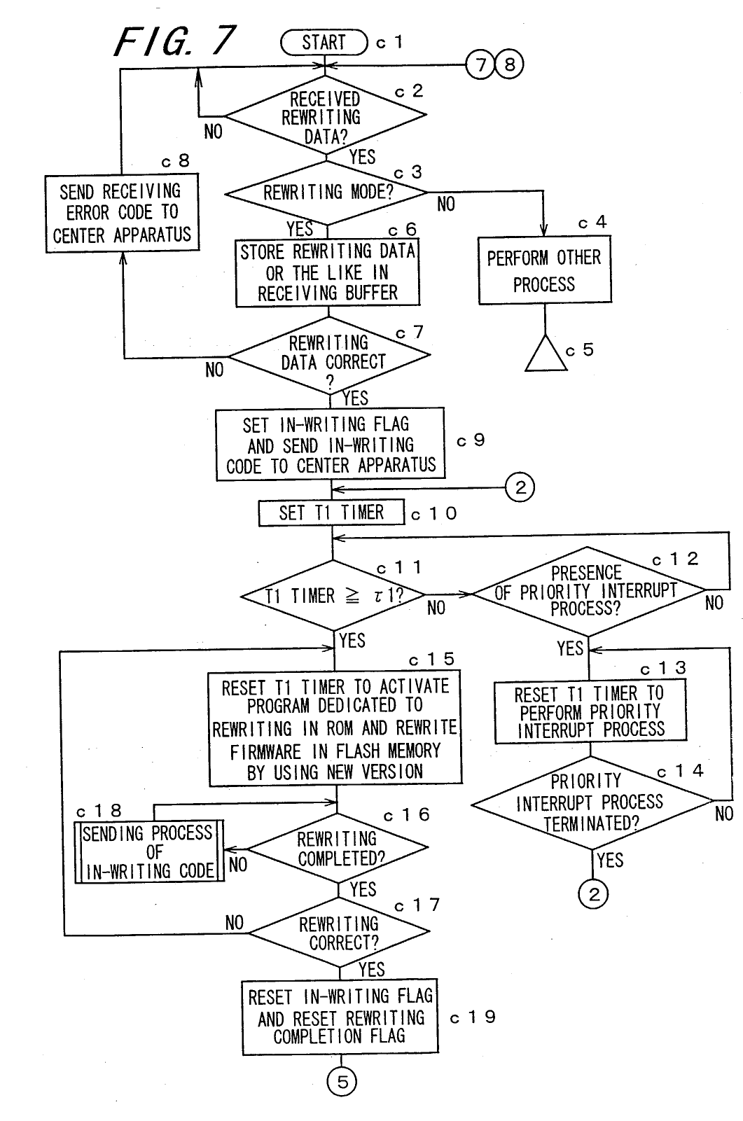

FIG. 7 is a flowchart showing the rewriting process of the firmware in the terminal apparatus A. This process is a process subsequent to the request process for rewriting start shown in FIG. 3.

At step c1, the terminal apparatus A starts the rewriting process of the firmware. At step c2, the terminal apparatus A confirms whether the terminal apparatus A received the rewriting data 31. When the terminal apparatus A receives the rewriting data 31, the process proceeds to step c3. When the terminal apparatus A does not receive the rewriting data 31, the process enters awaiting state. At the step c3, the terminal apparatus A confirms whether the rewriting mode flag is set, in other words, whether the terminal apparatus A is in the rewriting mode. When the terminal apparatus A is in the rewriting mode, the process proceeds to step c6. When the terminal apparatus A is not in the rewriting mode, the process proceeds to step c4. At the step c4, the terminal apparatus A performs other process. And at the step c5, the process is terminated.

At the step c6, the rewriting data 31 and the writing request command are stored in the receiving buffer 14. At step c7, the terminal apparatus A activates the sum check program 16 and checks whether an error occurs in the rewriting data 31 by using CRC (Cyclic Redundancy Check) or the like. A normal rewriting data 31 without any error can be written in the flash memory 3 and rewriting the firmware can be certainly performed by performing writing the rewriting data 31 after checking the rewriting data 31 as described above.

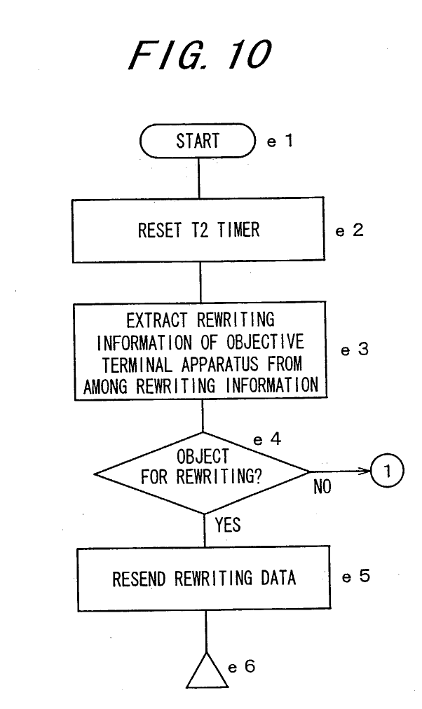

When any error does not occur in the rewriting data 31 and the rewriting data 31 is correct, the process proceeds to step c9. When an error occurs in the rewriting data 31 and the rewriting data 31 is not correct, the process proceeds to step c8. At the step c8, the terminal apparatus A sends e-mail with an attached receiving error code to the center apparatus B and the process returns to the step c2. In addition, as to a process to be performed in the center apparatus B having received the receiving error code, the process is described later by using FIG. 10.

At step c9, the terminal apparatus A confirms that the rewriting data 31 is correct and then sets the in-writing flag and also sends e-mail to which an in-writing code is attached, to the center apparatus B. At step c10, the terminal apparatus A sets the T1 timer 7 with a setting time τ1=2 sec. Setting of the setting time τ1 to the T1 timer 7 as described above enables the terminal apparatus A to monitor whether a process performed by an original function of the terminal apparatus A such as receiving in a facsimile or the like, in other words, priority interrupt process arises before lapse of the setting time τ1.

At step c11, the terminal apparatus A judges whether the setting time τ1 has elapsed. When the setting time τ1 has elapsed, the process proceeds to step c15. When the setting time τ1 has not been elapsed, the process proceeds to step c12. At the step c12, the terminal apparatus A judges whether there is priority interrupt process. Here, automatic receiving facsimile image data from the PSTN 18 through the line control portion 11 and printing of the facsimile image at the print portion 10 are thought of as time consuming process in assumed priority interrupt processes. The time required for the priority interrupt process is assumed as approximately 100 seconds in consideration of a case where the facsimile image extends across at least a plurality of pages. On the assumption that the time required for writing the rewriting data in the flash memory 3 in the terminal apparatus A is approximately several tens of milliseconds, the time required from writing start to writing completion becomes approximately 100 milliseconds even in consideration of the time required for checking an error in the rewriting data 31 and the time required for rewriting the rewriting data 31. The time of 100 milliseconds is one-thousandth of the time required for the priority interrupt process. Consequently, when any priority interrupt process does not arise in spite of lapse of the setting time τ1 set to the T1 timer, probability that any priority interrupt process will arise within 100 milliseconds subsequent to the setting time τ1 becomes extremely low. Therefore, as mentioned above, the terminal apparatus A can monitor whether a priority interrupt process arises by the T1 timer 7.

When the terminal apparatus A judges that a priority interrupt process arises, the process proceeds to step c13. When the terminal apparatus A judges that a priority interrupt process does not arise, the process returns to the step c11. At the step c13, the terminal apparatus A resets the T1 timer 7 and performs the priority interrupt process. At step 14, the terminal apparatus A confirms whether the priority interrupt process is completed. When the priority interrupt process is completed, the process returns to the step c10. When the priority interrupt process is not completed, the process returns to the step c13.

At the step c15, the terminal apparatus A resets the T1 timer 7 and activate the program dedicated to rewriting in the ROM 4 and rewrite the firmware in the flash memory 3 into the new version of the firmware. At step c16, the terminal apparatus A judges whether rewriting of the firmware is completed. When the rewriting of the firmware is completed, the process proceeds to step c17. When the rewriting of the firmware is not completed, the process proceeds to step c18. At the step c18, the terminal apparatus A performs a sending process of an in-writing code.

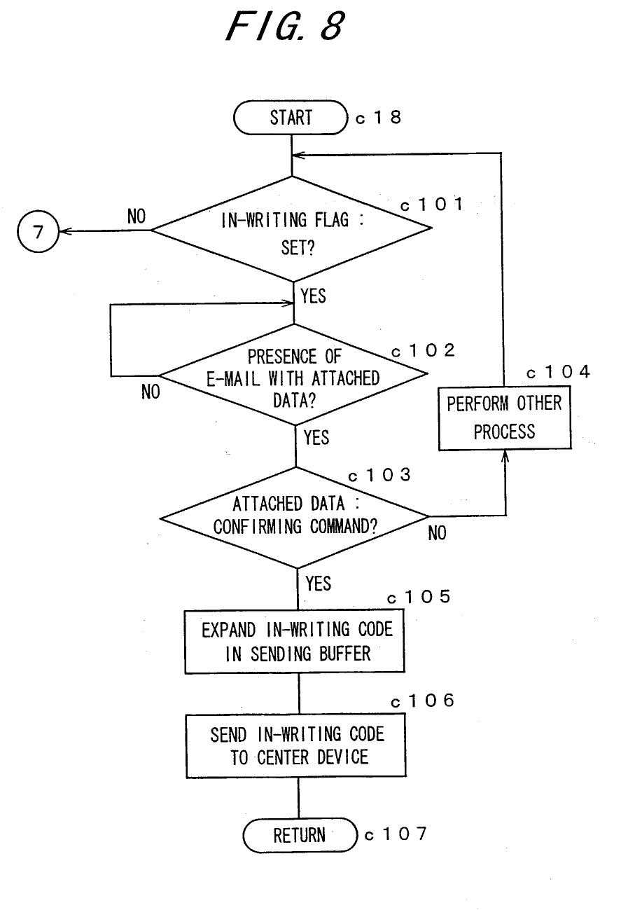

Here, the sending process of the in-writing code is described in detail. FIG. 8 is a flowchart showing details of the sending process of the in-writing code at the step c18. At the step c18, the terminal apparatus A starts the sending process of the in-writing code. At step c101, the terminal apparatus A confirms whether the in-writing flag is set. When the in-writing flag is set, the process proceeds to step c102. When the in-writing flag is not set, the process returns to the step c2 shown in FIG. 7. At the step c102, the terminal apparatus A confirms whether the terminal apparatus A receives an e-mail with attached data. When the terminal apparatus A receives the e-mail with attached data, the process proceeds to step c103. When the terminal apparatus A does not receive the e-mail with attached data, the process enters a waiting state.

At the step c103, the terminal apparatus A checks whether the attached data is a confirming command by the command processing portion 5. When the attached data is the confirming command, the process proceeds to step c105. When the attached data is not the confirming command, the process proceeds to step c104. At the step c104, the terminal apparatus A performs other process.

At the step c105, the terminal apparatus A expands the in-writing code in the sending buffer 15 as attached data to the e-mail. At step c106, the terminal apparatus A sends the e-mail to which the in-writing code is attached, to the center apparatus B. And at step c107, the process returns to the step c18 shown in FIG. 7. Thus, the terminal apparatus A sends the in-writing code during the period of performing the writing of the rewriting data 31 as a process responding to the confirming command. Therefore, the center apparatus B can confirm the rewriting condition of the firmware in the terminal apparatus A.

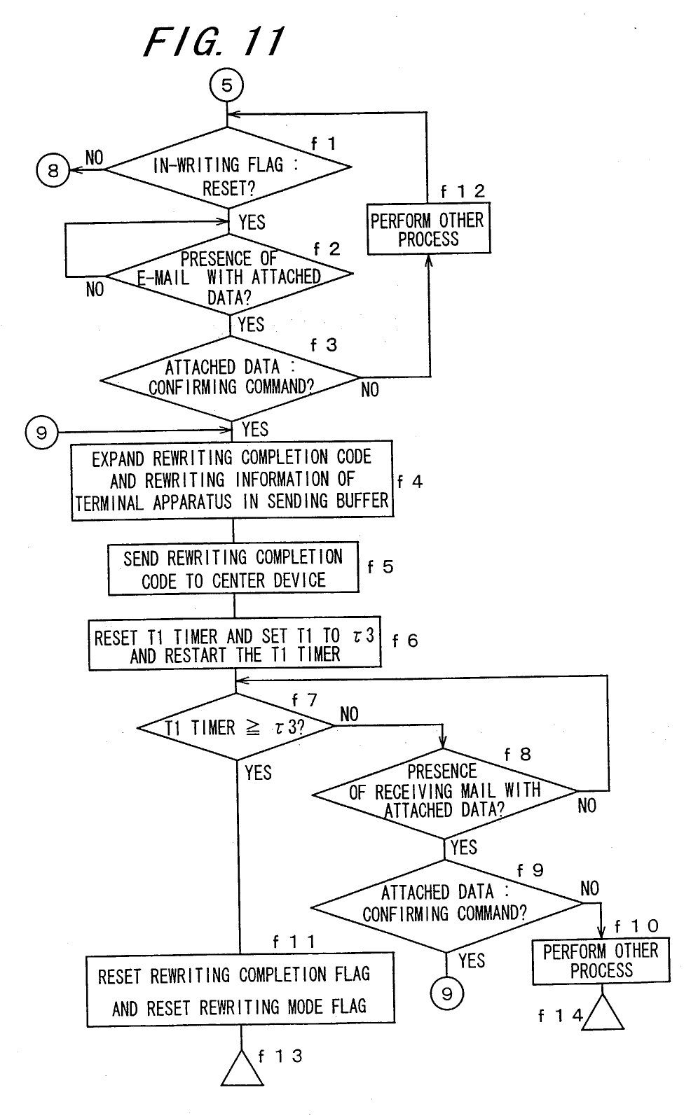

With reference to FIG. 7 again, at the step c17, the terminal apparatus A checks the firmware by the sum check program 16 to judge whether the rewriting of the firmware is correct. When the firmware is correctly rewritten, the process proceeds to step c19. On the other hand, when the firmware is not correctly rewritten, the process returns to the step c15 and the rewriting of the firmware is performed again. At the step c19, the terminal apparatus A resets the in-writing flag and sets the rewriting completion flag. And then the process proceeds to step f1 in FIG. 11.

Next, description is given concerning a process of the center apparatus B to be performed while the terminal apparatus A performs the rewriting of the firmware as mentioned above.

FIG. 9 is a flowchart showing a confirming process of a rewriting condition in the center apparatus B. This process is a process subsequent to the sending process of the rewriting data 31 shown in FIG. 5 and also a process corresponding to the rewriting process in the terminal apparatus A shown in FIG. 7. The process proceeds to step d1 from the step b10 shown in FIG. 5. At the step d1, the center apparatus B resets an in-writing code reply number counter Nw which is arranged on a register of the CPU 21 and then defines the Nw as 0. This in-writing code reply number counter Nw counts times of sending the in-writing code sent from the terminal apparatus A. The step d1 is a step to be performed just after the rewriting data 31 are sent and it is impossible for the center apparatus B to receive the in-writing code. Therefore, the center apparatus B defines the Nw as 0.

At step d2, the center apparatus B judges whether the setting time τ2 set in the T2 timer 27 has elapsed. When the setting time τ2 has elapsed, the process proceeds to step d3. When the setting time τ2 has not elapsed, the process proceeds to step d9. At the step d9, the center apparatus B confirms whether the center apparatus B received an e-mail with attached data. When the center apparatus B receives the e-mail, the process proceeds to step d7. When the center apparatus B does not receive the e-mail, the process returns to the step d2.

At the step d3, the center apparatus B sets an e-mail with an attached confirming command to the sending data memory 35. At step d4, the center apparatus B sends the e-mail with the attached confirming command to the terminal apparatus A. At step d5, the center apparatus B resets and restarts the T2 timer 27. Thus, resetting and restarting the T2 timer 27 enables the confirming command to be sent to the terminal apparatus A. Even when the terminal apparatus A does not response to the confirming signal for any reason, the center apparatus B can certainly grasp the rewriting condition in the terminal apparatus A by a subsequent confirming signal and perform the rewriting of the firmware more certainly.

At step d6, the center apparatus B confirms whether the center apparatus B received an e-mail with attached data. When the center apparatus B received the e-mail, the process proceeds to step d7. When the center apparatus B does not receive the e-mail, the center apparatus B continues monitoring of e-mail until the center apparatus B receives an e-mail with attached data. At the step d7, the center apparatus B investigates whether the attached data is an in-writing code. When the attached data is an in-writing code, the process proceeds to step d8. When the attached data is not a in-writing code, the process proceeds to step d10.

At the step d8, the center apparatus B adds 1 to a value of the in-writing code reply number counter Nw. And the process returns to the step d2. In this way, in the invention, it is important that the center apparatus B counts the in-writing code reply number. This is because the number of the in-writing code reply number counter Nw is referred to judging whether rewriting process performed by the center apparatus B has been normally completed.

At step d10, the center apparatus B investigates whether the attached data is a rewriting completion code. When the attached data is a rewriting completion code, the process proceeds to step d11. When the attached data is not a rewriting completion code, the process proceeds to step d14. At the step 14, the center apparatus B performs other process and the process returns to the step d6.

At the step d11, the center apparatus B judges whether the value of the in-writing code reply number counter Nw is equal to or more than 1. When the terminal apparatus A works normally and the rewriting process is started, the terminal apparatus A sends the in-writing code to the center apparatus B at the point of time of receiving the rewriting data 31. Therefore, the center apparatus B receives the in-writing code surely once. Thus, since the terminal apparatus A sends the in-writing code at least once or more times, when the value of the in-writing code reply number counter Nw is satisfied with Nw≧1 at the time of receiving the rewriting completion code, the center apparatus B judges that the rewriting process has been correctly performed. When the value of the in-writing code reply number counter Nw is satisfied with Nw=0 at the time of receiving the rewriting completion code, the center apparatus B judges that the rewriting process has not been correctly performed. When the value of the in-writing code reply number counter Nw is satisfied with Nw≧1, the process proceeds to step d12. When the value of the in-writing code reply number counter Nw is satisfied with Nw=0, the process proceeds to step d15. At the step d15, the center apparatus B requests the terminal apparatus A to perform the start process for rewriting again. And at step d16, the center apparatus B terminates the confirming process of the rewriting condition.

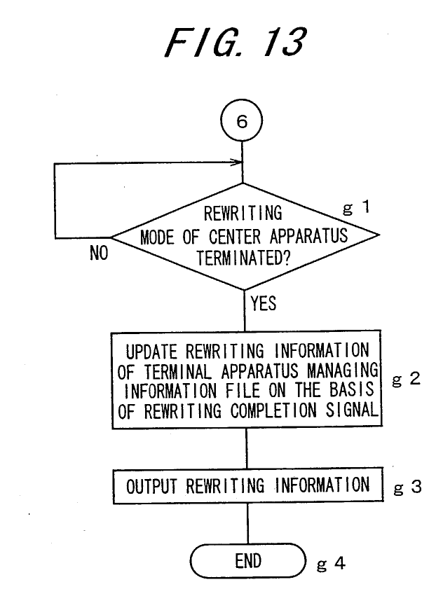

At the step d12, the terminal apparatus A resets the T2 timer 27 to make timer operation stopped. At step d13, the center apparatus B resets the rewriting mode flag and the process proceeds to step g1 in FIG. 13.

Here, description is given concerning a process to be performed when the center apparatus B receives an receiving error code from the terminal apparatus A.

FIG. 10 is a flowchart showing a resending process of the rewriting data 31 in the center apparatus B. The center apparatus B which received an e-mail with an attached receiving error code from the terminal apparatus A starts the resending process of the rewriting data 31 at step e1. At a state e2, the center apparatus B resets the T2 timer 27 and restarts the T2 timer 27. At step e3, the center apparatus B refers to the e-mail address of the terminal apparatus A included in the e-mail with the attached receiving error code and extracts rewriting information 50 of the relevant terminal apparatus A from among rewriting information 50 in the terminal apparatus managing information file 29. At step e4, the center apparatus B refers to the rewriting information 50 and judges whether the relevant terminal apparatus A corresponds to an object of rewriting. When the relevant terminal apparatus A corresponds to the object of rewriting, the process proceeds to step e5. When the relevant terminal apparatus A does not correspond to the object of rewriting, the process returns to the step b11 in FIG. 5. At step e5, the center apparatus B sends the rewriting data 31 which is expanded in the sending data memory 35 to the terminal apparatus A to be the object of rewriting again. And at step e6, the center apparatus B terminates the resending process of rewriting data 31.

Thus, the center apparatus B can confirm from the receiving error code that an error occurs in the rewriting data 31 at the time of receiving in the terminal apparatus A. When the error occurs, the rewriting of the firmware can be certainly performed by resending the rewriting data 31.

Next, description is given concerning a procedure in which the terminal apparatus A having judged that rewriting the firmware is correctly completed sends the rewriting completion code to the center apparatus B and resets the rewriting completion flag.

FIG. 11 is a flowchart showing a sending process of the rewriting completion code in the terminal apparatus A. This process is a process subsequent to rewriting process of the firmware shown in FIG. 7. The process proceeds to step f1 from the step c19 in FIG. 7. At the step f1, the terminal apparatus A confirms whether the in-writing flag is reset. When the in-writing flag is reset, the process proceeds to step f2. When the in-writing flag is not reset, the process returns to the step c2 in FIG. 7. At the step f2, the terminal apparatus A confirms whether the terminal apparatus A receives an e-mail with attached data. When the terminal apparatus A receives the e-mail with attached data, the process proceeds to step f3. When the terminal apparatus A does not receive the e-mail with attached data, the process enters a waiting state.

At step f3, the terminal apparatus A investigates whether the attached data is a confirming command. When the attached data is the confirming command, the process proceeds to step f4. When the attached data is not the confirming command, the process proceeds to step f12. At the step f12, the terminal apparatus A performs other process and the process returns to the step f1.

At the step f4, the terminal apparatus A expands the rewriting completion code and rewriting information 50 of the terminal apparatus A, for instance, the Version No. and the rewriting completion date and time or the like in the sending buffer 15 and attaches the rewriting completion code and the rewriting information 50 of the terminal apparatus A to an e-mail. At step f5, the terminal apparatus A sends an e-mail with an attached rewriting completion code or the like to the center apparatus B.

At step f6, the terminal apparatus A resets the T1 timer 7 and restarts the T1 timer 7 with the setting time defined as 13. The setting time 13 is defined as a little longer time than the time τ2 which is the sending cycle of the confirming command sent from the center apparatus B. The value of τ3 is concretely defined as 120 sec corresponding to 1.5 times the value of τ2 (=80 sec). And at step f7, the terminal apparatus A confirms whether the setting time τ3 has elapsed. Thus, confirming whether the setting time τ3 has elapsed enables the terminal apparatus A to confirm whether sending of the confirming command from the center apparatus B is terminated and to judge whether the center apparatus B has terminated rewriting process. When the setting time τ3 has elapsed, the process proceeds to step f11. When the setting time τ3 has not elapsed, the process proceeds to step f8. At the step f11, the terminal apparatus A resets the rewriting completion flag and the rewriting mode flag. And at step f13, the terminal apparatus A terminates the sending process of the rewriting completion signal.

At the step f8, the terminal apparatus A confirms whether the terminal apparatus A receives an e-mail with attached data. When the terminal apparatus A receives the e-mail with attached data, the process proceeds to step f9. When the terminal apparatus A does not receive the e-mail with attached data, the process returns to the step f7.

At the step f9, the terminal apparatus A investigates whether the attached data of the e-mail is a confirming command. When the attached data is the confirming command, the process returns to step f4. When the attached data is not the confirming command, the process proceeds to step f10. At the step f10, the terminal apparatus A performs other process, and at step f14, the terminal apparatus A terminates the process.

Thus, when the terminal apparatus A responds to the confirming command and rewriting process is completed, the terminal apparatus A sends the rewriting completion code. Therefore, the center apparatus B can confirm the rewriting condition of the firmware in the terminal apparatus A. In addition, The center apparatus B judges that the rewriting of the firmware in the terminal apparatus A is completed only when the terminal apparatus A receives the in-writing signal from the terminal apparatus A and then receives the rewriting completion signal. Therefore, the center apparatus B can prevent malfunction like completion of the rewriting process in spite of rewriting process performed incorrectly and can certainly perform rewriting the firmware.

In addition, description is given by using a time chart concerning a sequential process related to rewriting the firmware in the program data rewriting system.

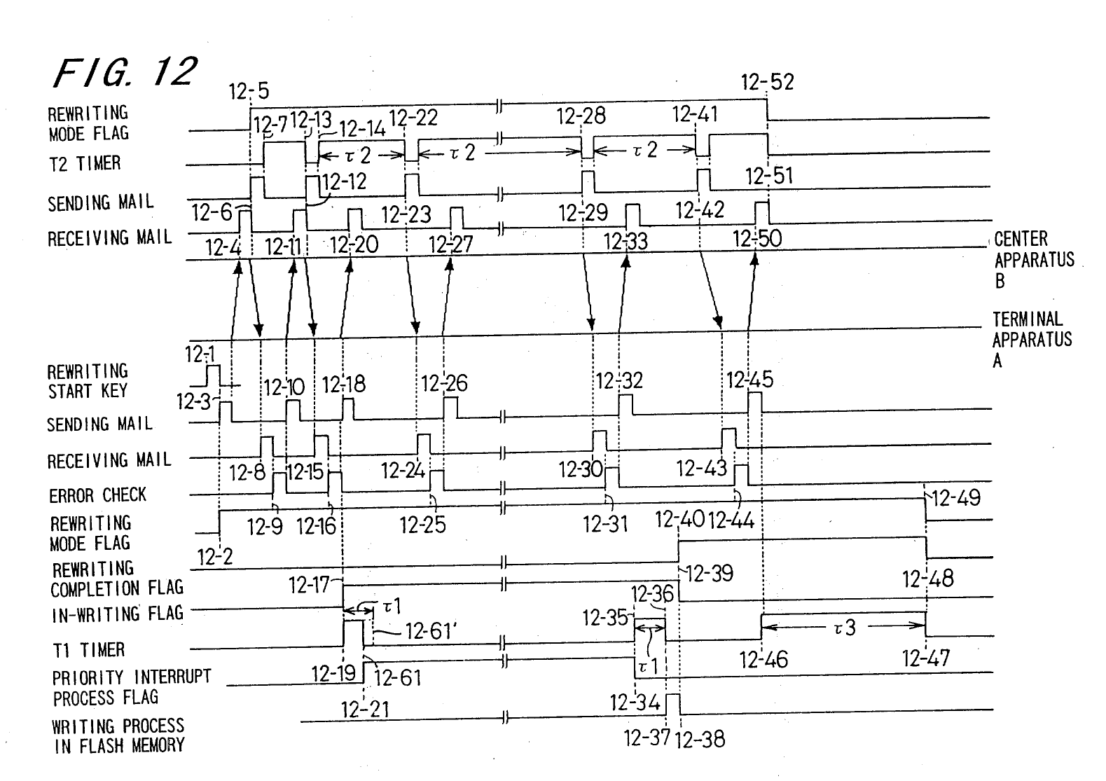

FIG. 12 is a time chart showing a schematic view of the rewriting process of firmware in the program data rewriting system.

When the rewriting start key arranged on the panel portion 9 of the terminal apparatus A is depressed by the system operator for the terminal apparatus A at a point of time (12-1), the terminal apparatus A activates the program dedicated to rewriting and starts the rewriting process of the firmware. And the terminal apparatus A sets the rewriting mode flag in the CPU 1 at a point of time (12-2). This makes the terminal apparatus A be in the rewriting mode. The terminal apparatus A requests the center apparatus B to rewrite the firmware with setting the rewriting mode flag and therefore sends an e-mail with an attached rewriting start command, to the center apparatus B at a point of time (12-3).

On the other hand, when the center apparatus B receives the e-mail with the attached rewriting start command from the terminal apparatus A at a point of time (12-4), the center apparatus B sets the rewriting mode flag in the CPU 21 at a point of time (12-5). This makes the center apparatus B be in rewriting mode. And the center apparatus B sends the rewriting data 31 and an e-mail with an attached writing request command to the terminal apparatus A at a point of time (12-6). The center apparatus B sets the T2 timer 27 and sets T2 as 80 sec at a point of time (12-7).

The terminal apparatus A receives the rewriting data 31 and the e-mail with the attached writing request command sent from the center apparatus B at a point of time (12-8). And the terminal apparatus A activates the sum check program 16 and checks whether an error occurs in the rewriting data 31 by CRC (Cyclic Redundancy Check) or the like at a point of time (12-9). When an error occurs in the rewriting data 31, the terminal apparatus A attaches a receiving error code to an e-mail and sends the e-mail to the center apparatus B at a point of time (12-10).

When the center apparatus B receives the e-mail with the attached receiving error code at a point of time (12-11), the center apparatus B resends the rewriting data 31 to the terminal apparatus A again at a point of time (12-12). The center apparatus B resets the T2 timer 27 with resending the rewriting data 31 at a point of time (12-13) and restarts the T2 timer 27 at a point of time (12-14).

The terminal apparatus A receives the rewriting data 31 resent from the center apparatus B at a point of time (12-15). And the terminal apparatus A activates the sum check program 16 and checks whether an error occurs in the rewriting data 31 at a point of time (12-16). When any error does not occur in the rewriting data 31, the terminal apparatus A sets the in-writing flag at a point of time (12-17) and also sends an e-mail with the attached in-writing code to the center apparatus B at a point of time (12-18). And the terminal apparatus A sets T1 timer 7 at a point of time (12-19).

The center apparatus B receives the e-mail with the attached in-writing code at a point of time (12-20). And the center apparatus B adds 1 to the value of the in-writing code reply number counter Nw which is arranged on a register of the CPU 21.

When priority interrupt process arises, the terminal apparatus A sets the priority interrupt process flag at a point of time (12-21) and performs this priority interrupt process prior to the rewriting process of the firmware. In FIG. 12, priority interrupt process arises during lapse of the first τ1 (=2 seconds) of the T1 timer 7 and therefore the T1 timer7 is reset at a point of time (12-61). When any priority interrupt process does not arise, the writing process must have been terminated just after lapse of the first τ1 at a point of time (12-61′) without delay of writing process in the flash memory 3 at a point of time (12-37). Even if the terminal apparatus A performs still performs the priority interrupt process, the in-writing flag of the terminal apparatus A is kept set from the point of time (12-17) to the point of time (12-39).

During that time, the setting time τ2 (=80 sec), which is set to the T2 timer 27, has elapsed and therefore the center apparatus B attaches a confirming command to an e-mail and sends the e-mail to the terminal apparatus A at a point of time (12-23).

The terminal apparatus A receives the e-mail with the attached confirming command at a point of time (12-24). And the terminal apparatus A activates the sum check program 16 and checks whether an error occurs in the rewriting data 31 at a point of time (12-25). When an error does not occur in the rewriting data 31, the terminal apparatus A refers to the condition of the flag. When the in-writing flag is set, the terminal apparatus A sends e-mail to which the in-writing code is attached to the center apparatus B at a point of time (12-26).

The center apparatus B receives the e-mail to which the in-writing code is attached at a point of time (12-27) and the center apparatus B adds 1 to the value of the in-writing code reply number counter Nw which is arranged on the register of the CPU 21.

Subsequently, the center apparatus B sends an e-mail with an attached confirming command to the terminal apparatus A at each of points of time (12-29) and (12-42) whenever the setting time τ2 (=80 sec) has elapsed at each of points of time (12-28) and (12-41).

On the other hand, when the terminal apparatus A receives the e-mail with the attached confirming command at a point of time (12-30), the terminal apparatus A checks whether an error occurs in the received e-mail at a point of time (12-31). And when an error does not occur, the terminal apparatus A refers to the condition of the flag and while the in-writing flag is set from the time (12-17) to the time (12-39), the terminal apparatus A sends an e-mail to which the in-writing code is attached, to the center apparatus B at a point of time (12-32).

The center apparatus B receives the e-mail which is sent from the terminal apparatus A and to which the in-writing code is attached at a point of time (12-33).

The terminal apparatus A monitors whether the priority interrupt process flag has been terminated. When the priority interrupt process flag is reset at a point of time (12-34), the terminal apparatus A sets the setting time τ1 (=2 sec) to the T1 timer 7 at a point of time (12-35). When there is no priority interrupt process before the setting time τ1 has elapsed at a point of time (12-36), the terminal apparatus A resets the T1 timer 7. And the terminal apparatus A activates the program dedicated to rewriting in the ROM 4 and rewrites the firmware in the flash memory 3 into the new version of the firmware from a point of time (12-37) to a point of time (12-38).

In addition, the terminal apparatus A resets the in-writing flag at a point of time (12-39) and sets the rewriting completion flag at a point of time (12-40). At this stage the rewriting mode flag is still kept set. This is because the terminal apparatus A does not notify the center apparatus B whether rewriting is completed for the confirming command sent from the center apparatus B.

When the setting time τ2 (=80 sec) has elapsed at a point of time (12-41) after a point of time (12-38) at which rewriting the flash memory 3 is terminated in the terminal apparatus A, the center apparatus B sends an e-mail with an attached confirming command, to the terminal apparatus A at a point of time (12-42).

The terminal apparatus A receives the e-mail at a point of time (12-43) and checks whether an error occurs in the e-mail at a point of time (12-44). And when there is no error in the e-mail, the terminal apparatus A refers to the condition of the flag. And when the writing completion flag is set, the terminal apparatus A sends the rewriting completion signal, Version No. and the data of date and time of rewriting completion, to the center apparatus B at a point of time (12-45).

After the terminal apparatus A sends the rewriting completion signal or the like to the center apparatus B, the terminal apparatus A defines the setting time τ3 of the T1 timer 7 as 120 sec and restarts the T1 timer 7 at a point of time (12-46). This is because the terminal apparatus A monitors sending of the confirming command sent from the center apparatus B. When the confirming command is not sent from the center apparatus B in spite of lapse of the setting time 13 at a point of time (12-47), the terminal apparatus A judges that the rewriting process is completed in the center apparatus B, and resets the completion flag at a point of time (12-48) and resets the rewriting mode flag at a point of time (12-49).

On the other hand, the center apparatus B receives the e-mail with the attached rewriting completion code at a point of time (12-50) and confirms that the rewriting completion code reply number counter Nw is satisfied with Nw≧1 and then the center apparatus B resets the T2 timer 27 and stops the T2 timer 27 at a point of time (12-51). In addition, the center apparatus B resets the rewriting mode flag at a point of time (12-52).

Thus, the resending of the rewriting data 31 is automatically started by reception of the error signal in the center apparatus B. Therefore, the process from detecting the error in the rewriting data 31 to resending rewriting data 31 can be quickly performed and occurrence of a human error can be prevented and rewriting the firmware can be certainly performed because any chance concerned with a human hand is lost. In addition, even if priority interrupt process arises during rewriting the firmware, the priority interrupt process is performed prior to other process and the rewriting process is automatically resumed after the priority interrupt process is terminated. Consequently, any chance concerned with a human hand is lost. This enables occurrence of a human error to be prevented and enables rewriting the firmware to be certainly performed.

Next, description is given concerning a procedure in which the center apparatus B manages the rewriting information 50 of the terminal apparatus A and outputs the rewriting information 50.

FIG. 13 is a flowchart showing an output process of the rewriting information 50 in the center apparatus B.

At step g1, the center apparatus B confirms whether its rewriting mode is terminated by checking the rewriting mode flag. When the rewriting mode is terminated, the process proceeds to step g2. When the rewriting mode is not terminated, the process returns to the g1. At the step g2, the center apparatus B extracts the version No. data and the rewriting completion date and time data which are attached to the received rewriting completion code. This enables the center apparatus B to get information about which version has been used for rewriting the current version of the terminal apparatus A and information about when rewriting the firmware has been completed.

And the center apparatus B updates the information about “New version No.” and “Rewriting completion date/time” included in the rewriting information 50 in the terminal apparatus managing information file 29 on the basis of these information. At step g3, the center apparatus B outputs the rewriting information 50 by using the recording portion 37 in order to inform an administrator or the like of the rewriting information. At step g4, the output process of the rewriting information 50 is completed. Thus, managing information, which is conventionally batch-processed by a human hand, can be automatically updated.

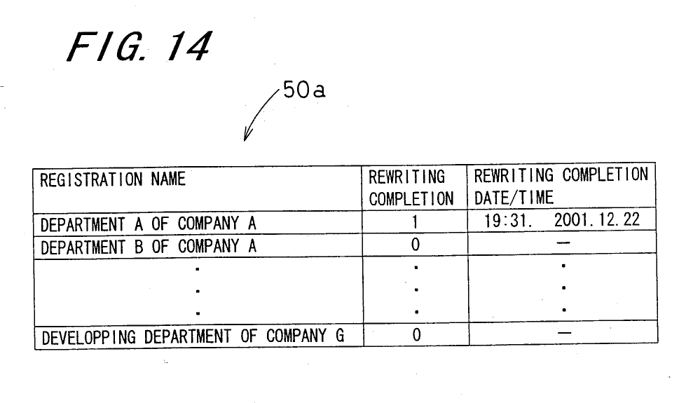

FIG. 14 is a table showing an outputted rewriting information 50a. The outputted rewriting information 50a which comprises information items related to a registered name, rewriting completion and a rewriting completion date/time. A number “1” denoting rewriting completion or a number “0” denoting rewriting incompletion is designated for the item related to rewriting completion. Consequently, it is easy to identify rewriting completion from rewriting incompletion. In addition, whether rewriting process is necessary or not for all the terminal apparatuses A can be judged and management of the terminal apparatuses A can be efficiently performed. Furthermore, the latest rewriting information 50a can be informed to the administrator of the program data rewriting system.

In this embodiment as mentioned above, the rewriting process is performed by the center apparatus B while the rewriting condition in the terminal apparatus A is being grasped by the center apparatus B in the program data rewriting system. Therefore, the rewriting of the firmware can be performed more certainly. In addition, when an error is detected in the rewriting data 31 received by the terminal apparatus A, the resending of the rewriting data can be quickly and automatically performed by the center apparatus B and therefore occurrence of a human error can be prevented. In addition, even if priority interrupt process arises during rewriting the firmware, the priority interrupt process is performed prior to others and the rewriting process is automatically resumed after the priority interrupt process is terminated and therefore even when priority interrupt process arises, occurrence of a human error can be prevented. Furthermore, malfunction like completion of the rewriting process in spite of rewriting process performed incorrectly can be prevented.

The center apparatus B can get not only information that rewriting process has been completed but rewriting information 50 about which version of the firmware has been used for the rewriting process in the terminal apparatus A and about when the rewriting process has been completed. Therefore, whether rewriting process is necessary or not for all the terminal apparatuses A can be judged and management of the terminal apparatuses A can be efficiently performed. Furthermore, whenever the rewriting process is completed in the terminal apparatus A, the center apparatus B outputs the rewriting information 50 and therefore the latest rewriting information 50a can be informed to the administrator of the program data rewriting system.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A program data rewriting system comprising:
a terminal apparatus including storing means which can be rewritten and in which program data are stored; and
a center apparatus which sends rewriting data to be used for rewriting the program data in the terminal apparatus to the terminal apparatus,
the program data rewriting system performing rewriting the program data by using a method by which the terminal apparatus receives the rewriting data sent from the center apparatus and writes the received rewriting data in the storing means,
wherein the terminal apparatus comprises signal sending means for sending an in-writing signal to the center apparatus during a period of writing the received rewriting data and sending a rewriting completion signal to the center apparatus after all the rewriting data are written and a rewriting of program data is completed, and
wherein the center apparatus comprises condition confirming means for judging that the rewriting of the program data in the terminal apparatus is completed when the rewriting completion signal is received after receiving the in-writing signal from the terminal apparatus.

2. The program data rewriting system of claim 1, wherein the center apparatus sends a confirming signal for confirming a condition of rewriting the program data in the terminal apparatus to the terminal apparatus by the condition confirming means after sending the rewriting data, and
wherein the terminal apparatus sends the in-writing signal or the rewriting completion signal by the signal sending means after receiving the confirming signal.

3. The program data rewriting system of claim 2, wherein the confirming signal is sent more than one time.

4. The program data rewriting system of claim 1, wherein the terminal apparatus further comprises checking means for checking whether an error occurs in the received data or not, and
wherein the terminal apparatus sends the in-writing signal to the center apparatus by the signal sending means when the rewriting data are checked by the checking means after the terminal apparatus receives the rewriting data and any error does not occur in the received data.

5. The program data rewriting system of claim 1, wherein the terminal apparatus further comprises checking means for checking whether an error occurs in the received data or not, and
wherein the terminal apparatus sends a receiving error signal to the center apparatus by the signal sending means when the rewriting data are checked by the checking means after the terminal apparatus receives the rewriting data and an error occurs in the received data, and the center apparatus resends the rewriting data after the center apparatus receives the receiving error signal.

6. The program data rewriting system of claim 1, wherein the terminal apparatus further comprises instruction means for instructing a start of rewriting the program data, and sends a rewriting start signal to the center apparatus according to an instruction of rewriting the program data from the instruction means, and
wherein the center apparatus sends the rewriting data to the terminal apparatus after receiving the rewriting start signal.

7. The program data rewriting system of claim 1, wherein the rewriting completion signal includes information about version and date and time of rewriting completion respectively of the program data.

8. The program data rewriting system of claim 1, wherein the center apparatus sends the rewriting data to a plurality of terminal apparatuses and performs rewriting program data, and
wherein the center apparatus further comprises rewriting information storing means for storing rewriting information about what terminal apparatus is completed and what terminal apparatus is not completed concerning rewriting of program data, among the terminal apparatuses.

9. The program data rewriting system of claim 8, wherein the center apparatus further comprises output means for outputting the rewriting information.

10. The program data rewriting system of claim 1, wherein the in-writing signal is a signal which is sent and received in accordance with a predetermined rule between the terminal apparatus and the center apparatus.

11. The program data rewriting system of claim 2, wherein the confirming signal is a signal which is sent and received in accordance with a predetermined rule between the terminal apparatus and the center apparatus.

12. The program data rewriting system of claim 1, wherein the rewriting completion signal is a signal which is sent and received in accordance with a predetermined rule between the terminal apparatus and the center apparatus.

13. The program data rewriting system of claim 5, wherein the receiving error signal is a signal which is sent and received in accordance with a predetermined rule between the terminal apparatus and the center apparatus.

14. The program data rewriting system of claim 1, wherein the program data are firmware.
